(19) United States
(12) Patent Application Publication
(10) Pub. No.: US 2017/0349795 A1
(43) Pub. Date: Dec. 7, 2017

(54) LOW TEMPERATURE CURABLE ADHESIVES AND USE THEREOF

(71) Applicant: Dow Global Technologies LLC, Midland, MI (US)

(72) Inventors: Bharati Balijepalli, Madland, MI (US); Glenn G. Eagle, Bloomfield Hills, MI (US)

(21) Appl. No.: 15/531,820

(22) PCT Filed: Feb. 8, 2016
(86) PCT No.: PCT/US2016/016947

§ 371 Date: May 31, 2017

Related U.S. Application Data
(60) Provisional application No. 62/114,638, filed on Feb. 11, 2015.

(51) Int. Cl. C09J 163/00; C09J 11/08

(52) U.S. Cl. CPC C09J 163/00; C09J 11/08

(57) ABSTRACT

An epoxy adhesive composition having a higher level (at or above 5 wt %) of a blocked tertiary amine catalyst, a urethane toughener, an epoxy resin modified with liquid rubber, a core shell rubber toughener and a combination of liquid and solid epoxy resins and the making thereof.

### FIELD OF THE INVENTION

The present invention relates to a novel epoxy adhesive composition with high impact strength and can be cured at a low temperature of about 130° C.

### INTRODUCTION

Typical crash durable adhesives (CDAs) are storage-stable, one-part epoxy adhesives with high impact resistance and high bond strength. All current CDAs require temperatures above 155° C. to cure satisfactorily and to develop the desired mechanical properties.

Presently in the automotive market, there are applications that require CDAs to cure rapidly at lower temperatures, i.e., as low as 130° C. For example, in some applications, it is required to cure the adhesive compositions in 10 minutes at 130° C. while having a shelf life of at least 45 days at 35° C. aging.

There are one-part epoxy adhesive compositions that can be cured at such low temperatures but none were available that have a reasonable shelf life, desired impact performance, and lap shear strength, since generally these properties are mutually exclusive. Improving one of them causes a deterioration of one or all of the other properties.

Therefore, it is desirable to design an adhesive composition that can satisfy the above described needs.

### SUMMARY OF THE INVENTION

It has been surprisingly found that with inclusion of a high level concentration of a catalyst and a unique combination of tougheners, a new storage stable adhesive composition can be designed to cure at low temperature and with unique/acceptable mechanical properties. Specifically, the present invention provides an epoxy adhesive composition that comprises a higher level (at or above 3 wt %) of a blocked tertiary amine catalyst, a urethane toughener, an epoxy resin modified with liquid rubber, a core shell rubber toughener and a combination of liquid and solid epoxy resins.

### DETAILED DESCRIPTION OF THE INVENTION

The present invention provides an epoxy adhesive composition that comprises a blocked tertiary amine catalyst, a urethane toughener, an epoxy resin that is modified with liquid rubber, a core shell rubber toughener and a combination of liquid and solid epoxy resins.

The blocked tertiary amine catalyst is present in a high concentration. One example of such blocked tertiary amine catalyst that can be used in the present invention is disclosed in US Patent Publication No. 2013/0090431, incorporated herein by reference in its entirety, and the most preferred catalyst is made using Example 5 of US Patent Publication No. 2013/0090431. The amount of such blocked tertiary amine catalyst present in the present composition can be above 3 wt %, preferably above 4 wt %, and more preferably above 5 wt %, all based on the total weight of the adhesive composition. In the mean time, the amount of such blocked tertiary amine catalyst present in the present composition is preferably below 8 wt %, preferably below 7 wt %, and more preferably below 6 wt %, all based on the total weight of the adhesive composition.

The unique combination of various types of tougheners used in the present composition is important to achieve the desired curing conditions and properties, storage stability, as well as other desired mechanical properties. In the present invention, the combination of tougheners includes a urethane toughener, an epoxy resin that is modified with liquid rubber, a core shell rubber toughener.

The preferred urethane tougheners are those tougheners described in U.S. Pat. No. No. 8,404,787 ('787 patent), incorporated herein by reference in its entirety. The most preferred urethane toughener for the present invention is Example 2 of the '787 patent (“Toughener A”). The urethane tougheners may be present in the adhesive composition in the amount of between 15 to 25 wt %, preferably between 20 to 25 wt %, and most preferably between 22 to 24 wt.%, all based on the total weight of the adhesive composition. For purpose of comparison, a toughener described in Example 13 of U.S. Pat. No. 5,278,257, incorporated herein by reference in its entirety, is used in various samples and is referred to as Toughener B.

The second toughener in the combination of tougheners is an epoxy resin that is modified with liquid rubber. Preferably, the rubber-modified epoxy resin is an epoxy-terminated adduct of an epoxy resin and at least one liquid rubber that has epoxide-reactive groups, in particular, carboxyl groups. The rubber is preferably a homopolymer of a conjugated diene or copolymer of a conjugated diene, especially a diene/nitrile copolymer. The conjugated diene rubber is preferably butadiene or isoprene, with butadiene being especially preferred. The preferred nitrile monomer is acrylonitrile. Preferred copolymers are butadiene-acrylonitrile copolymers. The rubbers preferably contain, in the aggregate, no more than 30 wt % of polymerized unsaturated nitrile monomer, and preferably no more than about 26 wt % of polymerized nitrile monomer. The rubber preferably contains from about 1.5, more preferably from about 1.8, to about 2.5, more preferably to about 2.2, epoxide-reactive terminal groups per molecule, on average. Carboxyl-terminated rubbers are preferred.

Suitable carboxyl-functional butadiene and butadiene/acrylonitrile rubbers are commercially available from Noveon as Hycar® 2000×162 carboxyl-terminated butadiene homopolymer and Hycar® 1300×31, Hycar® 1300×8, Hycar® 1300×13, Hycar® 1300×9 and Hycar® 1300×18 carboxyl-terminated butadiene/acrylonitrile copolymers. The molecular weight (Mw) of these rubbers are suitably from about 2000 to about 6000, more preferably from about 3000 to about 5000. The rubber is formed into an epoxy-terminated adduct by reaction with an excess of an epoxy resin. Enough of the epoxy resin is provided to react with all of the epoxide-reactive groups on the rubber and to provide free epoxide groups on the resulting adduct without significantly advancing the adduct to form high molecular weight species. A ratio of at least two equivalents of epoxy resin per equivalent of epoxy-reactive groups on the rubber is preferred. More preferably, enough of the epoxy resin compound is used that the resulting product is a mixture of the carboxy terminated butadiene-acrylonitrile (“CTBN”)-adduct and some free epoxy resin compound. Typically, the rubber and an excess of the epoxy resin are mixed together with a polymerization catalyst and heated to a temperature of about 100 to about 250° C. in order to form the adduct. Useful catalysts for conducting the reaction between the rubber and the epoxy resin include those described below. Preferred catalysts for forming the rubber-modified epoxy resin include phenyl dimethyl urea and triphenyl phosphine.

A wide variety of epoxy resins can be used to make the rubber-modified epoxy resin toughener, including any of those described below. Preferred epoxy resins are liquid or solid glycidyl ethers of a bisphenol such as bisphenol A or bisphenol F. Halogenated, particularly brominated, resins can be used to impart flame retardant properties if desired. Liquid epoxy resin such as DER™ 354 resin, which is a diglycidyl ether of bisphenol F available from The Dow Chemical Company, is especially preferred.

Epoxy-CTBN adducts are sold in admixture with an epoxy resin under the trade name HyPox™ RK84 and the trade name HyPox RA1340, both commercially available from CVC Thermoset Specialties, Moorestown, N.J. Preferred examples of such epoxy-CTBN adduct toughener are commercially available from Huntsman under the trade name of EP 815 and from CVC Thermoset Specialities under the trade name HyPox RF1321CB1. The epoxy-CTBN adduct may be present in the adhesive composition in the amount of between 10 to 30 wt %, preferably between 12 to 20 wt %, more preferably between 12 to 16 wt %, and most preferably between 12 to 14 wt %, all based on the total weight of the adhesive composition.

A core shell rubber toughener is also used in the present adhesive composition as a toughener in the toughener combination. The core-shell rubber component is a particulate material having a rubbery core. Any core-shell rubber material may be used in the present invention. Some preferred core-shell rubber compositions are disclosed in U.S. Pat. Nos. 7,642,316 and 7,625,977, both incorporated herein by reference in their entireties. The rubbery core of such core shell rubber preferably has a Tg of less than −25° C., more preferably less than −50° C., and even more preferably less than −70° C. The Tg of the rubbery core may be well below −100° C. The core-shell rubber also has at least one shell portion that preferably has a Tg of at least 50° C. By “core,” it is meant an internal portion of the core-shell rubber. The core may form the center of the core-shell particle, or an internal shell or domain of the core-shell rubber. A shell is a portion of the core-shell rubber that is exterior to the rubbery core. The shell portion (or portions) typically forms the outermost portion of the core-shell rubber particle. The shell material is preferably grafted onto the core or is cross-linked. The rubbery core may constitute from 50 to 95%, especially from 60 to 90%, of the weight of the core-shell rubber particle.

The core of the core-shell rubber may be a polymer or copolymer of a conjugated diene such as butadiene, or a lower alkyl acrylate such as n-butyl-, ethyl-, isobutyl- or 2-ethylhexylacrylate. The core polymer may in addition contain up to 20% by weight of other copolymerized monounsaturated monomers such as styrene, vinyl acetate, vinyl chloride, methyl methacrylate, and the like. The core polymer is optionally cross-linked. The core polymer optionally contains up to 5% of a copolymerized graft-linking monomer having two or more sites of unsaturation of unequal reactivity, such as diallyl maleate, monoallyl fumarate, allyl methacrylate, and the like, at least one of the reactive sites being non-conjugated.

The core polymer may also be a silicone rubber. These materials often have glass transition temperatures below −100° C. Core-shell rubbers having a silicone rubber core include those commercially available from Wacker Chemie, Munich, Germany, under the trade name Genioperl™.

A particularly preferred core shell rubber is one described in U.S. 2007/0027233 (EP 1 632 533 A1), incorporated herein by reference in its entirety. Core-shell rubber particles as described in the document include a cross-linked rubber core, in most cases being a cross-linked copolymer of butadiene, and a shell which is preferably a copolymer of styrene, methyl methacrylate, glycidyl methacrylate and optionally acrylonitrile. The core-shell rubber is preferably dispersed in a polymer or an epoxy resin, also as described in the document. Preferred core-shell rubbers include those sold by Kaneka Corporation under the designation Kaneka Kane Ace™, including the Kaneka Kane Ace 15 and 20 series of products, including Kaneka Kane Ace MX 153, Kaneka Kane Ace MX 154, Kaneka Kane Ace MX 156, Kaneko, Kane Ace MX 257, and mixtures thereof. The products contain the core-shell rubber (CSR) particles pre-dispersed in an epoxy resin, at various concentrations. For example, Kane Ace MX 154 comprises 40% CSR, and Kane Ace MX 257 comprises 37% CSR.

The preferred core shell rubber is KANE ACE MX 257 commercially available from Kaneka Corporation. Such core shell rubber toughener may be present in the present adhesive composition in the amount of between 3 to 20 wt %, preferably between 8 to 16 wt %, more preferably between 10 to 15 wt %, and most preferably between 13 to 15 wt %, all based on the total weight of the adhesive composition.

The epoxy resins used in the present adhesive composition is preferably a mixture of various liquid and solid epoxy resins. Suitable epoxy resins include the diglycidyl ethers of polyhydric phenol compounds such as resorcinol, catechol, hydroquinone, bisphenol, bisphenol A, bisphenol AP (1,1-bis(4-hydroxylphenyl)-1-phenyl ethane), bisphenol F, bisphenol K, bisphenol M, tetramethylbiphenol, diglycidyl ethers of aliphatic glycols and polyether glycols such as the diglycidyl ethers of C2-24 alkylene glycols and poly(ethylene oxide) or poly(propylene oxide) glycols; polyglycidyl ethers of phenol-formaldehyde novolac resins, alkyl substituted phenol-formaldehyde resins (epoxy novalac resins), phenol-hydroxybenzaldehyde resins, cresol-hydroxybenzaldehyde resins, dicyclopentadiene-phenol resins and dicyclopentadiene-substituted phenol resins, and any combination thereof.

The epoxy resin preferably is a bisphenol-type epoxy resin or mixture thereof with another type of epoxy resin. Preferably the bisphenol type epoxy resin is a mixture of a solid epoxy resin dispersed in a liquid epoxy resin. The most preferred epoxy resins are bisphenol-A based epoxy resins and bisphenol-F based epoxy resins.

The epoxy resin mixture useful in the present invention comprises, based on the total weight of the epoxy resin mixture, about 25 to 45 wt % of solid epoxy resins (SER) such as D.E.R. 661 or D.E.R. 662 both commercially available from The Dow Chemical Company, and 55 to 75 wt % of liquid epoxy resins (LER) such as D.E.R. 330, D.E.R. 331, D.E.R. 332 and D.E.R. 383 also available from The Dow Chemical Company. In a preferred embodiment, such epoxy resin mixture comprises 37 wt % of D.E.R. 661 (SER), 46 wt % of D.E.R. 331 (LER) and 17 wt % of D.E.R. 330 (LER). The epoxy resin mixture may be present in the adhesive composition in the amount of between 20 to 40 wt %, preferably between 25 to 30 wt %, and more preferably between 26 to 28 wt %, all based on the total weight of the adhesive composition.

The adhesive epoxy composition of the present invention also comprises at least one hardener such as dicyandiamide. One preferred example of such hardener is Amicure™ CG1200 commercially available from Air Products. The hardener is present in the adhesive composition in the amount between 3.5 to 5.5 wt %, preferably between 4 to 5 wt %, and more preferable between 4.2 to 4.5 wt %, all based on the total weight of the adhesive composition.

The present adhesive composition may also comprise some other typical components and fillers in their typical amounts used in crash durable adhesive composition. The adhesive can further contain other additives such as diluents, plasticizers, extenders, pigments and dyes, fire-retarding agents, thixotropic agents, flow control agents, such as silicones, waxes and stearates, which can, in part, also be used as mold release agents, adhesion promoters, antioxidants and light stabilizers. These include 4 to 5 wt % of glycidyl ester of neodecanoic acid such as Cardura™ N10 available from Shell, 3.5 to 4.5 wt % of a fumed silica such as Cab-O-Sil™ TS 720 from Cabot, 0.3 to 0.5 wt % of ethylene/vinyl acetate powder such as Microthene available from Equistar, and 5 to 7 wt % of calcium oxide, all based on the total weight of the adhesive composition.

One preferred embodiment of the present adhesive composition comprises: based on the two weight of the adhesive composition,

a. 27.3 wt % of the preferred epoxy mixture as described above;

b. 22.1 wt % of a urethane toughener;

c. 13.0 wt % of a CTBN-epoxy adduct toughener;

d. 14.2 wt % of a core shell rubber toughener;

e. 0.7 wt % of a modified epoxy resin;

f. 4.3 wt % of a hardener;

g. 5.0 wt % of a blocked tertiary amine catalyst;

h. 3.0 wt % of glycidyl ester of neodecanoic acid;

i. 3.9 wt % of a fumed silica;

j. 0.4 wt % of ethylene/vinyl acetate powder; and

k. 6.0 wt % of calcium oxide.

l. 0.1 wt % of a colorant

### EXAMPLES

Some embodiments of the invention will now be described in detail in the following Examples, wherein all parts and percentages are by weight unless otherwise specified.

### Preparation of Inventive and Comparative Adhesive Composition Samples

Small batches of adhesive compositions were prepared using a dual asymmetric centrifugal Flack Tek speedmixer DAC 400 FVZ. The liquid components were all weighed into the speedmixer cup and mixed for 1 minute at 2200 rpm. All solid components except the blocked tertiary amine catalyst were then added and the contents mixed for 1 minute at 2200 rpm. After the container wall was scraped with a wooden tongue depressor, the sample was reinserted into speedmixer and mixing was repeated for a further 2 minutes. The sides were scraped down once again and the contents were allowed to cool to room temperature. As a final step, the blocked tertiary amine catalyst was added and the composition was mixed for a further minute. De-aeration of the sample under vacuum was performed in a Ross double planetary mixer.

Larger batches of the adhesive compositions were prepared using a double planetary vacuum mixer (Charles Ross and Son Co.) equipped with rectangular blades. Typically, all the liquid components were weighed directly into the mixing jar and the items mixed together at slow speed until homogeneous. The curing agent (such as Amicure CG 1200), other typical components such as fillers and colorant were then added one after the other and mixing process was repeated after each addition. Fumed silica was added slowly in small batches over a period of 10 to 20 minutes. Mixing was performed at a slow speed until the wetting of silica was complete. Mixing speed was then increased to the maximum and the batch was allowed to mix for a further 15 minutes to ensure proper dispersion of fumed silica. The blocked tertiary amine catalyst was added last and while the sample was mixing, it was de-aerated under a vacuum of 29 mm Hg. Care was taken to keep the temperature of the mix below 30° C. during the entire preparation process.

Components of various inventive and comparative samples are listed below in various tables to demonstrate the testing results.

### Testing Methods

Impact Peel Testing: Impact peel specimens were prepared and tested according to ISO 11343 standard methods. 0.8 mm thick GMC-5E cold rolled steel substrate obtained from ACT Laboratories, Inc. was used for the screening study. Test coupons of 20 mm×100 mm size were cut from a sheet of the substrate. The coupons were thoroughly cleaned with acetone. 10 mil thick Teflon tape was applied to one end of the coupon and also the middle of the coupon, at a distance of 30 mm from the first tape, such that the bonding area is 20 mm×30 mm A thin layer of Ferrocote 61A US oil was applied to the bonding area. Adhesive composition was then applied to the oiled bonding area and covered with another coupon on top to form the test specimen. The edges of the specimen were scraped clean with a spatula and the bond held together using clips while the specimen was cured in a programmable Blue M electric oven at the required bake cycle. After the cure was complete and the test specimens cooled to room temperature, each specimen was clamped in a vice and the free ends were bent to form a wedge that can be inserted in the instrument for impact testing. Impact testing was performed using an Instron Dynatup Crush Tower. Specimens were placed on a fixed wedge. The crosshead with a load cell and 100 lb weight attached was dropped from a fixed height on to the specimen at a velocity of 6.7 ft/sec. The cleavage force of the bond was recorded. Three specimens were tested for each adhesive composition sample and the average value is reported.

Lap Shear Testing: Lap shear specimens were prepared and tested according to ISO 4537 standard method. 1″×4″ strips were cut from 0.8 mm thick GMC-5E cold rolled steel substrate obtained from ACT Laboratories Inc. Each coupon was thoroughly cleaned with acetone and the bonding area was prepped with a thin layer of Ferrocote 61A US oil. The adhesive composition was applied to the oiled coupon and 10 mil size glass beads were sprinkled on top to ensure consistent bond thickness. A send coupon was laid on top using a fixture pre-set to the required 23 mm overlap. The edges of the joint were scraped clean using a spatula and the bond was held together using clips while the lap shear specimen was cured in a programmable Blue M electric oven at the required bake cycle. The lap shear strength of the specimens was measured using an Instron 5500R Materials Testing System. Pneumatic grips were used to hold the samples in place. The cross head speed was set at 5 mm/min. The load to failure of each specimen was then recorded. Three specimens were tested for each adhesive sample and the average value is reported.

Viscosity Measurement: All rheological measurements were conducted on an AR 2000 EX rheometer (TA Instruments). The test geometry used was a 25 mm stainless steel parallel plate with a temperature controlled Peltier plate. The test temperature was set to 38° C. A small amount of adhesive composition sample was dispensed onto the center of the Peltier plate and the gap was set at 475 microns. The excess adhesive composition that was squeezed out was scraped away using a spatula and the gap was reduced to 450 microns. The sample was subjected to a steady shear of 3 per second and the viscosity value recorded after 3 minutes is reported. The initial room temperature viscosity of all adhesive composition samples was measured immediately after preparation. A portion of each adhesive composition sample was then placed in a 2 oz glass jar. These samples were then placed in a calibrated Blue M electric oven set at 35° C. for heat aging. Samples were removed at regular time intervals and viscosity measured according to the procedure described above.

### Results

The data in Table 1 shows that the type of the urethane toughener used has a substantial influence on the stability of the adhesive composition. Use of Toughener A is more stable than the Toughener B regardless of the type of catalyst used in the system.

TABLE 1
Effect of Toughener A on stability

| | | Inventive | | Inventive |
|---|---|---|---|---|
| | Comparative | Example | Comparative | Example |
| Components | Example 1 | 1 | Example 2 | 2 |
| DER ™ 330 (an | 28.8 | 28.8 | 29.39 | 29.39 |
| epoxy resin) | | | | |
| Kane Ace MX 154 | 3 | 3 | 3.06 | 3.06 |
| CTBN-Epoxy Adduct | 27.2 | 27.2 | 27.76 | 27.76 |
| toughener | | | | |
| Toughener B | 20.6 | 10 | 21.02 | 10.2 |
| Toughener A | | 10.6 | | 10.82 |
| Cardura N10 | 3.1 | 3.1 | 3.16 | 3.16 |
| RAM 1087* | 0.7 | 0.7 | 0.71 | 0.71 |
| Amicure CG1200 | 4.4 | 4.4 | 4.49 | 4.49 |
| Fillers | 6.2 | 6.2 | 6.33 | 6.33 |
| Blocked tertiary amine | 6 | 6 | 0 | 0 |
| catalyst | | | | |
| Phenyl dimethyl urea | | | 3.57 | 3.57 |
| Lica 09** | | | 0.51 | 0.51 |
| Total | 100.00 | 100.00 | 100.00 | 100.00 |
| Initial Viscosity (Pa · s) | 136 | 104 | 116 | 91 |
| Viscosity after 2 weeks | 624.9 | 348.5 | 203.5 | 100.4 |
| @ 35 C. Aged | | | | |
| % higher than Initial | 359.5 | 235.1 | 75.4 | 10.3 |

*RAM 1087 is an optional epoxy silane agent available from Huntsman Corporation
**Lica 09, commercially available from Kenrich Petrochemicals Inc., is a titanate coupling agent, neoalkoxy titanate. It is an additive which improves adhesion, thermal stability and impact properties.

A direct comparison of stability of adhesive composition containing Toughener B vs. Toughener A is shown in Table 2. As can be observed, the composition containing Toughener A (Example 3) was far more stable with only 23% increase in viscosity after 2 weeks of aging at 35° C. compared to the Comparative Example 1 which showed a viscosity increase of ˜360% under the same conditions.

TABLE 2
Comparison of Storage Stability of formulations containing
Toughener B vs. those containing Toughener A

| | | Inventive |
|---|---|---|
| | Comparative | Example |
| Example | Example 1 | 3 |
| Epoxy resin | 28.8 | 26.3 |
| Core shell rubber dispersion | 3 | 4.9 |
| CTBN-Epoxy adduct toughener | 27.2 | 26.5 |
| Toughener B | 20.6 | |
| Toughener A | | 20.1 |
| Cardura N10 | 3.1 | 3.0 |
| RAM 1087 | 0.7 | 0.7 |
| Amicure CG1200 | 4.4 | 4.3 |
| Fillers | 6.2 | 8.3 |
| Blocked tertiary amine catalyst | 6 | 6 |
| Total | 100.00 | 100.00 |
| Initial Viscosity (Pa · s) | 136 | 219.9 |
| Viscosity after 2 weeks @ 35 C. Aged | 624.9 | 272 |
| % higher than Initial | 359.5 | 23.7 |

TABLE 3
Unique Combination of Tougheners required for high Impact
resistance as well as high Lap shear strength

| | Compar- | Compar- | Compar- | Inventive |
|---|---|---|---|---|
| | ative | ative | ative | Example |
| Examples | Example 3 | Example 4 | Example 5 | 4 |
| Kane Ace MX257 | 48.3 | | | 14.5 |
| CTBN-Epoxy Adduct | | 48.3 | | 13.3 |
| Toughener A | | | 48.3 | 22.4 |
| Epoxy resins mixture | 26.3 | 26.3 | 26.3 | 26.6 |
| RAM 1087 | 0.7 | 0.7 | 0.7 | 0.7 |
| CARDURA N10 | 3 | 3 | 3 | 3.0 |
| AMICURE CG1200 | 4.3 | 4.3 | 4.3 | 4.3 |
| Blocked Tertiary Amine | 7 | 7 | 7 | 5 |
| Fillers | 10.4 | 10.4 | 10.4 | 10.4 |
| Total | 100 | 100 | 100 | 100 |
| Impact resistance (N/mm) | 9.3 | 3.7 | 30.1 | 26.2 |
| Lap Shear Strength (MPa) | 15.1 | 14.1 | 12.6 | 17.3 |

Examples listed in Table 3 show that Toughener A has the greatest influence on the impact peel strength of the formulation, whereas the lap shear strength of the adhesive composition increases with increasing amounts of core shell rubber and CTBN-modified resin. However, none of the tougheners can be used alone to obtain the balance of properties (high impact peel strength and high lap shear strength). A unique combination of the three tougheners was found to be essential.

Inventive Example 4 has impact peel strength >25 N/mm, lap shear strength >16 N/mm and is also shelf stable for more than 6 weeks if aged at 35° C. or more than 3 months if aged at ambient room temperature.

### Inventive Example 5 Combines Mechanical Properties With Storage Stability (Properties When Cured for 10 Minutes at 130° C.)

| Inventive Example | 5 |
|---|---|
| Kane Ace MX257 | 14.2 |
| CTBN-Epoxy Adduct | 13.0 |
| Toughener A | 22.1 |
| Epoxy resin mixture | 27.3 |
| RAM 1087 | 0.7 |
| CARDURA N10 | 3.0 |
| AMICURE CG1200 | 4.3 |
| Blocked tertiary amine catalyst | 5 |
| Fillers | 10.4 |
| Total | 100 |
| Impact peel strength at RT (N/mm) | 26.2 |
| Impact peel strength at −40° C. (N/mm) | 23.1 |
| Lap Shear Strength at RT (MPa) | 17.3 |
| Initial Viscosity (Pa · s) | 274 |
| Viscosity after 6 weeks @ 35 C. Aged | 506.1 |
| % higher than Initial | 84.7 |
| Viscosity after 12 weeks @ RT Aged | 360.9 |
| % higher than Initial | 31.7 |

1. An adhesive composition comprising, based on total weight of the adhesive composition:
a. more than 3 wt % of a blocked tertiary amine catalyst;
b. a mixture of tougheners comprising urethane toughener, a rubber-modified epoxy resin toughener, and core shell rubber; and
c. an epoxy resin mixture of liquid epoxy resin and solid epoxy resin.

2. The adhesive composition of claim 1, wherein the rubber-modified epoxy resin toughener is an epoxy-terminated adduct of an epoxy resin and at least one liquid rubber having epoxide-reactive groups.

3. The adhesive composition of claim 2 wherein the epoxide-reactive groups comprises a carboxyl group.

4. The adhesive composition of claim 3 wherein the rubber-modified epoxy resin toughener is a carboxy terminated butadiene-acrylonitrile-epoxy adduct.

5. The adhesive composition of claim 1 wherein the mixture of tougheners is comprised of 15 to 25 wt % of the urethane toughener, 10 to30 wt % of the rubber-modified epoxy resin toughener, and 3 to 20 wt % of core shell rubber, all based on the total weight of the adhesive composition.

6. The adhesive composition of claim 1 comprising more than 5 wt % of a blocked tertiary amine catalyst, based on the total weight of the adhesive composition.
